(19) United States
(12) Patent Application Publication
(10) Pub. No.: US 2015/0050742 A1
(43) Pub. Date: Feb. 19, 2015

(54) Analysis of Occurrence of Corrosion Products with ZPGM and PGM Catalysts Coated on Metallic Substrates

(71) Applicant: Zahra Nazarpoor, Camarillo, CA (US)

(72) Inventor: Zahra Nazarpoor, Camarillo, CA (US)

(73) Assignee: CDTi, Ventura, CA (US)

(21) Appl. No.: 13/969,054

(22) Filed: Aug. 16, 2013

(51) Int. Cl. G01N 31/10

(52) U.S. Cl. CPC G01N 31/10
USPC 436/37

(57) ABSTRACT

The present disclosure provides identification techniques on platinum group metal (PGM) and zero platinum group metal (ZPGM) catalyst systems, in order to identify responsible materials for the formation of corrosion products, such as hexavalent chromium compounds. Identification analyses, such as X-ray diffraction analysis (XRD) and X-ray fluorescence (XRF) may be performed on various thermally treated PGM and ZPGM catalyst systems. Results of identification analyses may show that for both PGM and ZPGM catalysts, hexavalent chromium (Cr⁶⁺) may be formed during thermal aging at range of 600C to 900C. This may be due to the high concentration of chromium in substrate alloys. Therefore, occurrence of corrosion and production of hexavalent chromium may initiate from elements found in the substrate and not from elements within the PGM and ZPGM catalysts. Additionally, tests regarding washcoat adhesion and back pressure performed on disclosed PGM and ZPGM catalyst systems show that presence of corrosion products does not affect the quality of ZPGM and PGM catalyst systems.

### CROSS-REFERENCE TO RELATED APPLICATIONS

The present disclosure is related to U.S. patent application Ser. No. 13/927,940, titled “Methods for Identification of Materials Causing Corrosion on Metallic Substrates within ZPGM Catalyst Systems”, filed Jun. 20, 2013, the entirety of which is incorporated by reference as if fully set forth herein.

N/A

### BACKGROUND

1. Field of the Disclosure

The present disclosure relates in general to catalyst systems, and, more specifically, to formation of corrosion products on metallic substrates within Zero Platinum Group Metal (ZPGM) and Platinum Group Metal (PGM) catalyst systems.

2. Background Information

Catalysts in catalytic converters may be manufactured to decrease pollution caused by exhaust gases from automobiles, utility plants, processing, manufacturing plants, trains, airplanes, mining equipment and other engine-equipped machinery. Problems with the manufacture of catalyst systems may include the presence of corrosion products on these catalyst systems. Formulations of catalysts systems may include at least a substrate, a washcoat and an overcoat, where the catalysts systems may include Zero Platinum Group Metal (ZPGM) or Platinum Group Metal (PGM) catalysts.

In catalyst systems with applications in motorcycles and similar devices, metallic catalyst support structures or substrates may be preferred over inorganic (e.g., ceramic) catalyst substrates. There may be many alloys employed as substrates for catalyst systems, which may include corrosive metals such as iron, chromium, among others. Additionally, washcoats and overcoats within catalyst systems may include elements that may also contribute to formation of corrosion products.

Therefore, there is a need for methods for identifying materials within substrates, washcoats or overcoats in PGM and ZPGM catalyst systems that may contribute in the formation of corrosion products. This may be done in order to demonstrate ZPGM and PGM metals do not initiate the occurrence of corrosion in catalyst systems.

### SUMMARY

The present disclosure may provide a process to analyze occurrence of corrosion caused by formation of hexavalent chromium compounds, where the corrosion products may not affect zero platinum group metal (ZPGM) catalyst systems and Platinum Group Metal (PGM) catalyst systems.

The present disclosure may provide an identification analysis to detect material compositions that may be responsible for the formation of corrosion products in ZPGM catalyst systems and PGM catalyst systems. Current techniques to be used in the identification analysis, as known in the art, may include, but are not limited to, X-ray diffraction analysis (XRD) and X-Ray Fluorescence (XRF).

According to one or more embodiments in the present disclosure, compositions of PGM and ZPGM catalyst systems may include any suitable combination of a metallic substrate, a washcoat, and an overcoat. Suitable washcoats, and/or overcoats may include ZPGM metal catalyst such as copper (Cu), cerium (Ce), and silver (Ag), amongst others. In another embodiment, washcoats and/or overcoats may include one or more PGMs, including Palladium (Pd), Platinum (Pt), and Rhodium (Rh), amongst others. Catalyst samples with metallic substrate of varied geometry and cells per square inch (CPSI) may be prepared using any suitable synthesis method as known in current art.

In one or more embodiments, disclosed PGM and ZPGM catalyst systems may include metallic substrates, which may include alloys of iron and chromium, among other alloys.

During thermal treatments of ZPGM and PGM system in the range of 600C to 900C, corrosion products in the form of hexavalent chromium (Cr 6+) compounds may form on the surface of substrate edge which may be identified by XRD and XRF.

According to embodiments of the present disclosure, the identification analysis may show that regardless of the metal catalyst, which may include PGM or ZPGM, hexavalent chromate may be formed during thermal aging at temperature greater than 600C and lower than 900° C.

XRD and XRF identification analyses may additionally show that formation of corrosion products may come from elements found in the metallic substrate (containing Cr and Fe), and not from elements found in the material composition within PGM or ZPGM metal catalysts.

The identification process may help manufacturers of PGM and ZPGM catalyst systems on metallic substrates to use any suitable composition of metallic substrates.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a structure of catalyst systems, according to an embodiment.

FIG. 2 shows an XRF analysis of an aged type-1 catalyst, according to an embodiment.

FIG. 3 shows an XRD analysis of an aged type-1 catalyst, according to an embodiment.

FIG. 4 shows an XRF analysis of an aged type-2 catalyst, according to an embodiment.

FIG. 5 shows an XRD analysis of an aged type-2 catalyst, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Definitions

As used here, the following terms may have the following definitions:

“Catalyst system” may refer to a system of at least two layers including at least one substrate, a washcoat, and/or an overcoat.

“Substrate” may refer to any material of any shape or configuration that yields a sufficient surface area for depositing a washcoat and/or overcoat.

“Washcoat” may refer to at least one coating including at least one oxide solid that may be deposited on a substrate.

“Overcoat” may refer to at least one coating that may be deposited on at least one washcoat layer.

“Catalyst” may refer to one or more materials that may be of use in the conversion of one or more other materials.

“Zero platinum group (ZPGM) catalyst” may refer to a catalyst completely or substantially free of platinum group metals.

“Platinum group metals” may refer to, platinum, palladium, ruthenium, iridium, osmium, and rhodium.

“Carrier material oxide” may refer to materials used for providing a surface for at least one catalyst.

“Oxygen storage material (OSM)” may refer to a material able to take up oxygen from oxygen rich streams and able to release oxygen to oxygen deficient streams.

“Treating,” “treated,” or “treatment” may refer to drying, firing, heating, evaporating, and calcining of a material, or any suitable mixture thereof.

“X-ray diffraction” or “XRD Analysis” may refer to a rapid analytical technique that investigates crystalline material structure, including atomic arrangement, crystalline size, and imperfections in order to identify unknown crystalline materials (e.g. minerals, inorganic compounds).

“X-ray fluorescence spectrometry” or “XRF Analysis” may refer to a spectrometric analysis that based on the principle that individual atoms, when excited by an external energy source, emit X-ray photons of a characteristic energy or wavelength, in order to identify and quantify the elements present within a sample.

“Edge” may refer to the connection of substrate lip and substrate matrix within catalyst systems.

### DESCRIPTION OF THE DRAWINGS

The present disclosure may relate to analysis of occurrence of corrosion in catalyst systems, where tested properties may include washcoat adhesion, and the catalytic activity of the systems. Suitable systems include zero platinum group metal (ZPGM) and Platinum Group Metal (PGM) catalyst systems that may form hexavalent chromate compounds, within metallic substrates, washcoat (WC) or overcoat (OC) that may contribute in the formation of corrosion products.

Catalyst System Structure

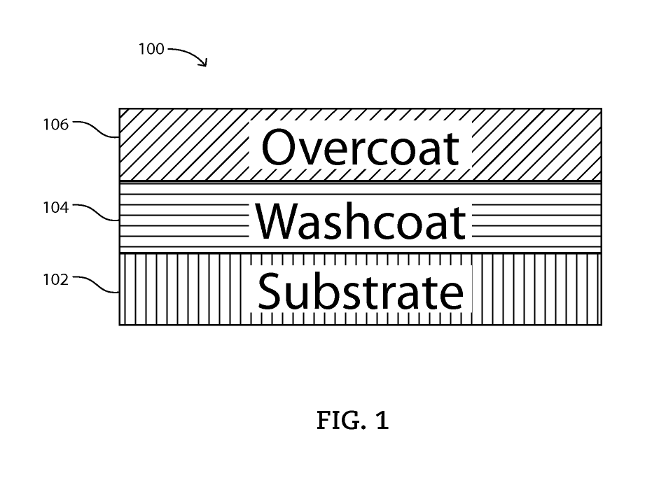

FIG. 1 illustrates a structure of ZPGM catalyst systems, referred to Catalyst System Structure 100; where Catalyst System Structure 100 may include Substrate 102, Washcoat 104 and Overcoat 106.

According to an embodiment, Substrate 102 may be any suitable metallic substrate, and may include substrates with about 17% w/w to about 19% w/w of chromium (Cr), less than about 0.6% w/w of nickel (Ni), about 0.9% w/w to about 1.5% w/w of molybdenum (Mo), less than about 1% w/w of silicon (Si), less than about 1% w/w of manganese (Mn), and balance of iron (Fe). Substrate 102 may be used with different dimensions and cell densities. In an embodiment, Substrate 102 may be 40 mm×60 mm, 300 cells per square inch (CPSI).

Washcoat 104 or Overcoat 106 may be prepared using co-milling or co-precipitation or any suitable methods known in the art. Washcoat 104 or Overcoat 106 may include PGM and ZPGM catalysts. Suitable ZPGM catalysts may include one or more ZPGM transition metals, and least one rare earth metal, or any suitable mixture thereof that may be completely free of platinum group metals. According to an embodiment, a suitable ZPGM transition metal catalyst within the disclosed Washcoat 104 or Overcoat 106 may be Ag, Cu and rare earth metal may be Ce. Suitable PGM catalysts may include may include one or more PGMs, including Palladium (Pd), Platinum (Pt), and Rhodium (Rh), amongst others within the disclosed Washcoat 104 or Overcoat 106.

Preparation of Type-1 Catalyst Systems

ZPGM catalyst systems including a similar to that described by FIG. 1 may be prepared, where suitable substrates of use may include metallic substrates with varying substrate geometry and cells per square inch (CPSI).

According to one or more embodiments of the present disclosure, suitable washcoats may include at least one ZPGM transition metal catalyst and a carrier material oxide. ZPGM transition metal catalysts may include one or more of scandium, manganese, iron, cobalt, nickel, copper, zinc, yttrium, niobium, molybdenum, silver, cadmium, tantalum, tungsten, and gallium.

In one or more embodiments, ZPGM transition metal catalysts may include silver, where suitable amounts of silver may include a range of about 1% w/w to about 20% w/w of the total catalyst weight; where amounts suitable for use in one or more embodiments may be of about 5% w/w to 10% w/w. ZPGM transition metal catalysts containing silver in said amounts may include one or more carrier material oxides within the washcoat, including alumina (Al₂O₃) or lanthanum doped alumina.

Suitable overcoats may include one or more ZPGM transition metals, including copper oxide, ceria, at least one carrier material oxides, and at least one oxygen storage material (OSM), which includes suitable mixtures of cerium (Ce), zirconium (Zr), neodymium (Nd), and praseodymium (Pr). Amounts of Copper (Cu) and Ce present in suitable overcoats may be about 5% w/w to about 50% w/w or from about 10% w/w to about 16% w/w of Cu; and about 12% w/w to about 20% w/w of Ce.

Carrier material oxides of use in overcoats may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for use in on or more overcoats disclosed here may include one or more selected from the group consisting of aluminum oxide (Al₂O₃) or doped aluminum oxide. Doped aluminum oxide in overcoats may include one or more selected from the group consisting of lanthanum, yttrium, lanthanides and mixtures thereof. Suitable amounts of doped lanthanum in alumina may vary from about 0% w/w (i.e., pure aluminum oxide) to about 10% w/w of lanthanum oxide. Other embodiments may include pure alumina (Al₂O₃) as a carrier material oxide. Carrier material oxides and OSMs included in overcoat may be present in a ratio of about 60% w/w to about 40% w/w.

Disclosed Type-1 catalysts may be prepared employing co-milling, co-precipitation or other any suitable preparation technique known in the art. After deposition, suitable washcoats and overcoats may undergo one or more suitable thermal treatments. This thermal treatment (aging) may be performed at about 300° C. to about 1100° C. In some embodiments, a thermal treatment may be performed heating catalyst systems to temperatures of about 900° C. The heat treatment may last from about 2 hours to about 6 hours. Most suitable thermal treatment may last about 4 hours. The WC and OC loading may vary from about 60 g/L to about 200 g/L, separately.

Preparation of Type-2 Catalyst Systems

PGM catalyst systems including a metallic substrate, and a washcoat (WC) may be prepared, where suitable metallic substrates of use may include substrates with varying substrate geometry and cells per square inch (CPSI).

According to one or more embodiments of the present disclosure, suitable washcoats may include at least one PGM transition metal catalyst and a carrier material oxide. PGM catalysts may include one or more of platium, palladium, and rhodium. In other embodiments, suitable washcoats may include one or more other PGMs.

Carrier material oxides of use in PGM catalyst may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for use in on or more washcoat disclosed here may include one or more selected from the group consisting of aluminum oxide (Al₂O₃) or doped aluminum oxide. Doped aluminum oxide in washcoat may include one or more selected from the group consisting of lanthanum, yttrium, lanthanides and mixtures thereof. Suitable amounts of doped lanthanum in alumina may vary from 0% w/w (i.e., pure aluminum oxide) to 10% w/w of lanthanum oxide. Other embodiments may include pure alumina (Al₂O₃) as a carrier material oxide. Carrier material oxides and OSMs included in washcoat may be present in a ratio of about 60% w/w to about 40% w/w.

Disclosed PGM catalyst systems may be prepared employing co-milling, co-precipitation or other any suitable preparation technique known in the art. After deposition, suitable washcoats may undergo one or more thermal treatments. This thermal treatment (aging) may be performed at about 300° C. to about 1100° C. In some embodiments, a thermal treatment may be performed heating PGM catalyst systems to temperatures of about 900° C. The heat treatment may last from about 2 hours to about 6 hours. Most suitable thermal treatment may last about 4 hours. The WC loading may vary from about 60 g/L to about 200 g/L.

Type-1 Catalyst: Analysis of Corrosion Product

In one or more embodiments, a Type-1 catalyst system, including silver in Washcoat 104 with a metallic substrate of D40×L60 (300 CPSI), may undergo thermal aging for about 4 hours at about 900° C. During temperature ramp up, at about 500° C., decomposition of silver oxide to metallic silver may take place. As type-1 catalyst systems reach about 600° C., formation hexavalent chromium (Cr⁶⁺) in the form of chromic acid vapor may take place, where chromic acid vapor may be considered toxic. Chromic acid vapor may be formed as chromium may be released from the substrate alloy. Then, as temperatures in the aging process reach about 650° C. to 700° C., a reaction between chromic acid and metallic silver may take place and Cr⁶⁺, in the form of silver chromate (Ag₂CrO₄) with an orange-red color, may be formed on the surface of the edge of Substrate 102.

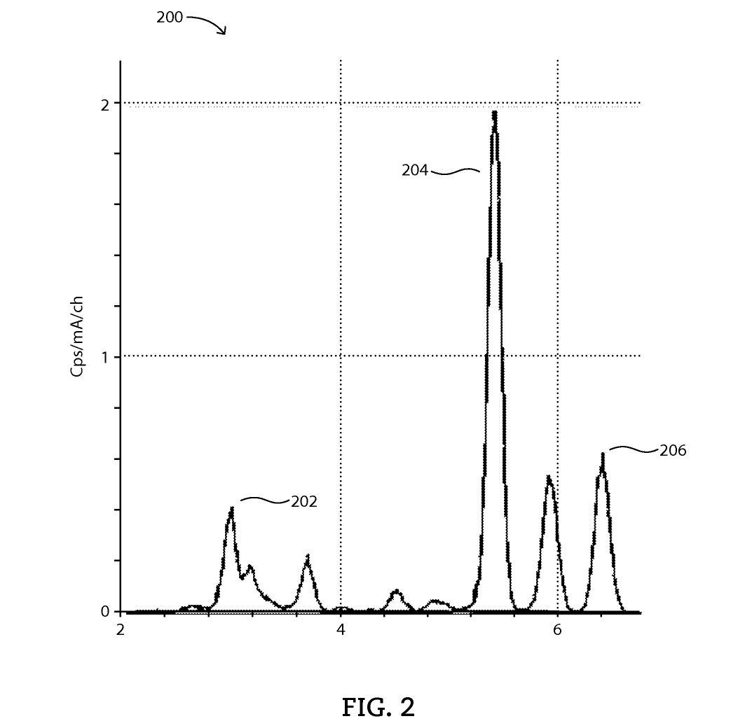

FIG. 2 shows XRF Pattern 200 for a type-1 catalyst system having undergone aging for about 4 hours at about 900° C., where the sample for XRF Pattern 200 is taken from the red material formed on the edge of the Substrate 102. The presence of silver, chromium, and iron in the red corrosion product, as indicated by Ag Peak 202, Cr Peak 204, and Fe Peak 206, may be observed, where the intensity of Cr Peak 204 may indicate a relatively large presence of Chromium. The presence of Cr and Fe may confirm the liberation of these elements from the alloy used in Substrate 102.

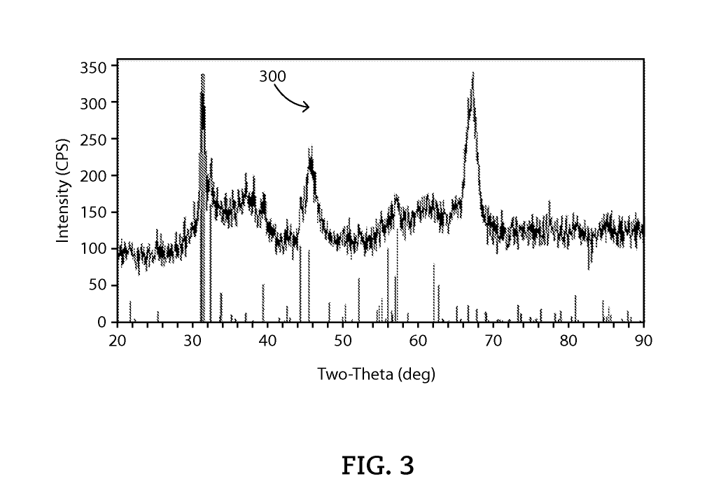

FIG. 3 shows XRD Pattern 300 for a type-1 catalyst system having undergone aging for about 4 hours at about 900° C., where the sample for XRD Pattern 300 is taken from the red material formed on the edge of Substrate 102. The main XRD diffraction peaks (signal) may be consistent with diffraction peaks of silver chromate (Ag₂CrO₄); thus showing that Ag₂CrO₄ (with hexavalent chromium) may be present on corrosion product within the catalyst system.

Type-2 Catalyst: Analysis of Corrosion Product

In one or more embodiments, a type-2 catalyst system, including Palladium in Washcoat 104, where the washcoat may be deposited on a metallic substrate, and may undergo aging for about 4 hours at about 900° C. After aging, formation of Palladium Chromate (PdCrO₄) may be observed on the edge of Substrate 102. During aging, as type-2 catalyst systems reach temperature of about 600° C., formation of hexavalent chromium (Cr⁶⁺) in the form of chromic acid vapor may take place, where chromic acid vapor may be considered toxic. Chromic acid vapor may be formed as chromium may be released from the alloy of Substrate 102. Then, as temperatures in the aging process reach about 650° C. to 700° C., a reaction between chromic acid and metallic palladium may take place and Cr 6+, in the form of palladium chromate (PdCrO₄) with a pinkish-red color, may be formed on the surface of substrate 102 edge.

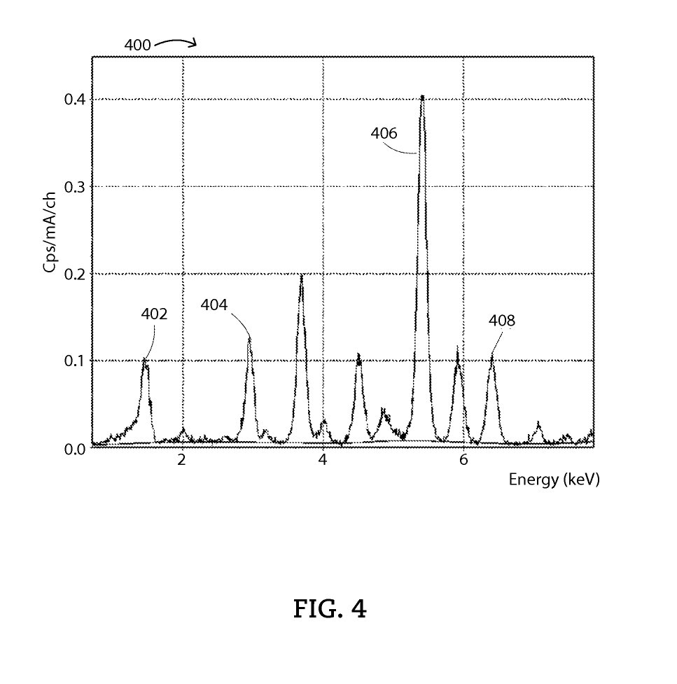

FIG. 4 shows XRF Pattern 400 for a type-2 catalyst system having undergone aging for about 4 hours at about 900° C., where the sample for XRF Pattern 400 is taken from the pink material formed on the edge of the Substrate 102. The presence of washcoat compounds (Aluminum and Palladium) and substrate 102 compounds (Chromium and Iron) in the material may be observed, as indicated by Al Peak 402, Pd Peak 404, Cr Peak 406, and Fe Peak 408. The presence of Cr and Fe may confirm the liberation of these elements from the alloy used in Substrate 102.

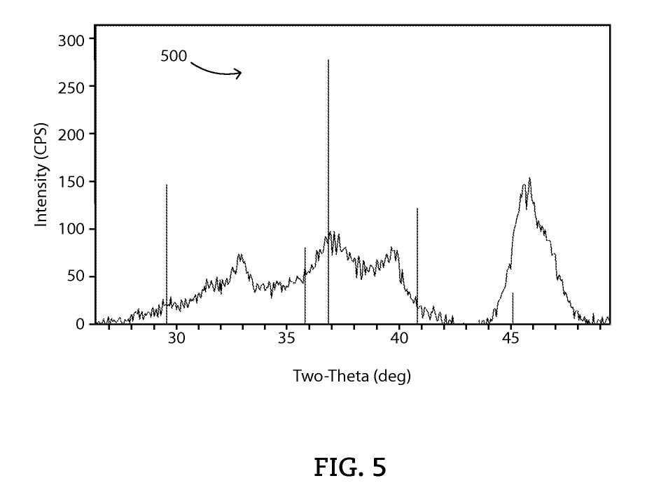

FIG. 5 shows XRD Pattern 500 of pink material formed after aging for about 4 hours at about 900° C. on the edge of the Substrate 102 lip in PGM catalyst. The main XRD diffraction peaks (signal) may be consistent with diffraction peaks of palladium chromate (PdCrO₄); thus showing that (PdCrO₄) (with hexavalent chromium) may be present on corrosion product within the catalyst system.

Influence of Chromate Products on Quality of Catalyst Systems

FIGS. 2, 3, 4 and 5 may indicate the formation of chromate compounds that may form from the corrosion caused by chromic acid vapor formation during the aging of type-1 and type-2 catalyst systems. In order to identify the influence of corrosion products on quality of the catalyst, type-1 and type-2 catalysts underwent the washcoat adhesion and back pressure test.

Verification of Washcoat Adhesion may be performed using any suitable adherence test known in the art. The washcoat adhesion test may be performed by quenching a preheated Substrate 102 at about 550° C. in cold water with angle of 45 degree for about 8 seconds followed by re-heating to about 150° C. and then blowing cold air at 2,800 L/min. Subsequently, weight loss may be measured to calculate weight loss percentage, which is % WCA loss in present disclosure.

Type-1 catalysts (ZPGM) having undergone heat treatment at about 550° C. and free of the orange-red corroded material may be subjected to a WCA test, where the loss may be found to be of about 2.2% WCA loss. Type-1 catalysts having undergone heat treatment at about 900° C. and showing orange-red corroded material may be subjected to a WCA test, where the loss may be found to be of about 1.9% WCA loss. It may be concluded that the presence of corrosion products may have negligible effects on WCA loss of ZPGM catalyst.

Type-2 catalysts (PGM) having undergone heat treatment at about 550° C. and free of the orange-red corroded material may be subjected to a WCA test, where the loss may be found to be of about 1.5% WCA loss. Type-1 catalysts having undergone heat treatment at about 900° C. and showing orange-red corroded material may be subjected to a WCA test, where the loss may be found to be of about 1.0% WCA loss. It may be concluded that the presence of corrosion products may have negligible effects on WCA loss of PGM catalyst.

Back pressure (BP) may be tested in a similar fashion, and may be found to also be negligibly affected by the presence of corrosion products from aging at 900° C. Back pressure testing may be performed on the coated substrate having an air flow of 1.0 m³/min, at 25° C.

Type-1 catalysts (ZPGM) having undergone heat treatment at about 550° C. and free of the orange- red corroded material may be subjected to a BP test, where BP may be found to be of about 0.417 kPa. Type-1 catalysts having undergone heat treatment at about 900° C. and showing orange-red corroded material may be subjected to a BP test, where BP may be found to be of about 0.415 kPa. BP of blank substrate is subject to measure and may be found to be 0.298 kPa. It may be concluded that the presence of corrosion products may have negligible effects on BP of ZPGM catalysts.

Type-2 catalysts (ZPGM) having undergone heat treatment at about 550° C. and free of the orange-red corroded material may be subjected to a BP test, where BP may be found to be of about 0.402 kPa. Type-1 catalysts having undergone heat treatment at about 900 ° C. and showing orange-red corroded material may be subjected to a BP test, where BP may be found to be of about 0.405 kPa. BP of blank substrate is subject to measure and may be found to be 0.298 kPa. It may be concluded that the presence of corrosion products may have negligible effects on BP of PGM catalysts.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for detecting corrosion in a catalytic system, comprising:
aging at least one catalyst system in communication with a substrate;
determining at least one color change on a surface of the at least one catalyst system, wherein the surface of the at least one catalyst system comprises one selected from the group consisting of a zero platinum group metal catalyst, a platinum group metal catalyst, and a combination thereof;
analyzing at least one portion of the surface using a method selected from the group consisting of X-ray diffraction analysis (XRD), X-Ray Fluorescence (XRF), X-ray Photoelectron Spectroscopy (XPS), and combinations thereof;
wherein at least one corrosive material is identified in the at least one catalyst system according to said analyzing.

2. The method according to claim 1, wherein the aging comprises heating from about 300° C. to about 1100° C.

3. The method according to claim 1, wherein the aging comprises heating for about 4 hours.

4. The method according to claim 1, wherein the aging comprises heating to about 900° C.

5. The method according to claim 1, wherein the aging comprises heating for about 4 hours.

6. The method according to claim 1, wherein the aging is performed under dry conditions.

7. The method according to claim 1, wherein the catalyst system comprises one selected from the group consisting of a washcoat, an overcoat, and combinations thereof.

8. The method according to claim 1, wherein the zero platinum group metal catalyst comprises one selected from the group consisting of copper, cerium, silver, and combinations thereof.

9. The method according to claim 1, wherein the platinum group metal catalyst comprises one selected from the group consisting of palladium, platinum, rhodium, and combinations thereof.

10. The method according to claim 1, wherein hexavalent chromium is identified in the catalyst system.

11. The method according to claim 10, wherein the hexavalent chromium is Ag₂CrO₄.

12. The method according to claim 10, wherein the hexavalent chromium is Cu₂(Cr₂O₇).

13. The method according to claim 1, wherein the at least one color change comprises green color.

14. The method according to claim 1, wherein the at least one color change comprises orange color.

15. The method according to claim 1, wherein the at least one color change comprises red-orange color.

16. The method according to claim 1, wherein the at least one color change comprises green-yellow color.

17. The method according to claim 1, wherein the at least one color change comprises pink-red color.

18. The method according to claim 1, wherein the at least one color change occurs proximate to an edge of the catalyst system.

19. The method according to claim 1, wherein the substrate comprises metal.

20. The method according to claim 19, wherein the metal is selected from the group consisting of iron, chromium, and combinations thereof.
